(19) United States
(12) Patent Application Publication
(10) Pub. No.: US 2024/0276242 A1
(43) Pub. Date: Aug. 15, 2024

(54) METHOD AND APPARATUS FOR EFFECTIVELY APPLYING ARTIFICIAL INTELLIGENCE OR MACHINE LEARNING IN A WIRELESS COMMUNICATION SYSTEM

(71) Applicant: Samsung Electronics Co., Ltd., Suwon-si (KR)

(72) Inventors: Feifei SUN, Beijing (CN); Zhe CHEN, Beijing (CN)

(21) Appl. No.: 18/442,517

(22) Filed: Feb. 15, 2024

(30) Foreign Application Priority Data
Feb. 15, 2023 (CN) 202310140928.9

(51) Int. Cl. H04W 24/02; H04L 41/16

(52) U.S. Cl. CPC H04W 24/02; H04L 41/16

(57) ABSTRACT

The disclosure relates to a 5G or 6G communication system for supporting a higher data transmission rate. A method executed by a user equipment (UE) in a wireless communication system is provided. The method includes monitoring an artificial intelligence (AI) model based on at least one measurement criterion, and transmitting model related information based on the monitoring result, wherein the measurement criterion comprises one or more beam performance related measurement metrics, and wherein the measurement criterion is used to monitor/evaluate performance of the AI model.

### CROSS-REFERENCE TO RELATED APPLICATION(S)

This application is based on and claims priority under 35 U.S.C. § 119(a) of a Chinese patent application number 202310140928.9, filed on Feb. 15, 2023, in the China National Intellectual Property Administration, the disclosure of which is incorporated by reference herein in its entirety.

### BACKGROUND

### 1. Field

The disclosure relates to the technical field of wireless communication. More particularly, the disclosure relates to a communication method, a user equipment and a base station.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-Long Term Evolution (LTE) systems”.

In order to achieve a higher data rate, 5G communication systems are implemented in higher frequency (millimeter (mmWave)) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

By applying artificial intelligence (AI)/machine learning (ML) in the wireless communication air interface technology, the performance can be improved (e.g., better beam selection accuracy, higher throughput, lower terminal power consumption, etc.). However, due to the generalization of the AI/ML, one AI/ML model may be trained for a specific scenario to optimize performance. However, when the scenario, environment or channel changes, the expected performance (e.g., better than the conventional algorithm) may not be obtained by applying this AI/ML model. In addition, in the process of designing/training AI/ML models, a plurality of AL/ML model may be trained/designed, so that at least one of the models can achieve better performance in one scenario, environment, channel or other conditions. Thus, how to manage AI/ML models is a problem urgently to be solved to achieve better performance. Therefore, it is necessary to provide an AI/ML model management method to achieve a better performance.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method, a user equipment and a base station.

Additional aspects will be set forth in part in the description which follows and, in part, will be apparent from the description, or may be learned by practice of the presented embodiments.

In accordance with an aspect of the disclosure, a method executed by a user equipment (UE) in a wireless communication system is provided. The method includes monitoring an artificial intelligence (AI) model based on at least one measurement criterion, and transmitting model related information based on the monitoring result, wherein the measurement criterion includes one or more beam performance related measurement metrics, and the measurement criterion is used to monitor/evaluate performance of the AI model.

In an optional embodiment of the disclosure, the measurement criterion further includes one or more evaluation criterions based on the measurement indicator.

In an optional embodiment of the disclosure, the one or more beam performance related measurement metrics include at least one of the following, an accuracy of one or more beams determined by the AI model, channel state information and/or a channel quality of one or more beams determined by the AI model, a confidence of one or more beams determined by the AI model, and a system performance of one or more beams determined by the AI model.

In an optional embodiment of the disclosure, the model related information includes at least one of a request for model management, a measurement result, a result for model management and assistance information for model management.

In an optional embodiment of the disclosure, the measurement criterion is determined by at least one of the following, configuration information for the measurement criterion, and model information of the AI model.

In an optional embodiment of the disclosure, the model information includes at least one of the following, an implementation entity of the AI model, information of applicable scenario of the AI model, an identity (ID) of the AI model and/or a functionality of the AI model, and an input and/or output parameter of the AI model.

In an optional embodiment of the disclosure, the method further includes performing model management by the UE.

In an optional embodiment of the disclosure, the model management is performed based on model management indication information, and the model management indication information is received from a base station, or, the model management is performed based on the measurement result and/or the at least one measurement criterion.

In an optional embodiment of the disclosure, the model management includes at least one of the following, model updating, model retraining, model switching, model activation, model deactivation, model downloading, and model uploading.

In an optional embodiment of the disclosure, the request for model management is determined based on the measurement result and/or the at least one measurement criterion.

In an optional embodiment of the disclosure, the transmitting model related information further includes transmitting model related information based on a preset trigger condition.

In an optional embodiment of the disclosure, the model management assistance information includes at least one of the following, environmental information of the UE, capability information of the UE, and information of the AI model applied in the UE.

In accordance with another aspect of the disclosure, a method executed by a base station in a wireless communication system is provided. The method includes receiving model related information of a user equipment (UE), the model related information being determined by monitoring an artificial intelligence (AI) model based on at least one measurement criterion by the UE, and transmitting model management indication information, wherein the measurement criterion includes one or more beam performance related measurement metrics, and the measurement criterion is used to monitor/evaluate the performance of the AI model.

In an optional embodiment of the disclosure, the method further includes transmitting model related configuration information, the configuration information including the at least one measurement criterion.

In an optional embodiment of the disclosure, the model related information includes at least one of a request for model management, a measurement result, a result for model management and assistance information for model management.

In accordance with another aspect of the disclosure, a user equipment (UE) is provided. The UE includes a transceiver, memory storing one or more computer programs, and a processor communicatively coupled to the transceiver and the memory, wherein the one or more computer programs include computer-executable instructions that, when executed by the one or more processors, cause the UE to monitor an artificial intelligence (AI) model based on at least one measurement criterion, and transmit model related information based on a monitoring result, wherein the measurement criterion comprises one or more beam performance related measurement metrics, and wherein the measurement criterion is used to monitor/evaluate performance of the AI model.

In accordance with another aspect of the disclosure, a base station is provided. The base station includes a transceiver, memory storing one or more computer programs, and one or more processors communicatively coupled to the transceiver and the memory, wherein the one or more computer programs include computer-executable instructions that, when executed by the one or more processors, cause the base station to receive model related information of a user equipment (UE), the model related information being determined by monitoring an artificial intelligence (AI) model based on at least one measurement criterion by the UE, and transmit model management indication information, wherein the measurement criterion comprises one or more beam performance related measurement metrics, and wherein the measurement criterion is used to monitor/evaluate performance of the AI model.

In accordance with another aspect of the disclosure, an electronic device is provided. The electronic device includes memory and a processor, wherein the memory has computer programs stored thereon, and the processor is configured to execute the computer programs to implement the methods provided in the embodiment of the first aspect or any optional embodiment of the first aspect and the embodiment of the second aspect or any optional embodiment of the second aspect.

In accordance with another aspect of the disclosure, one or more computer-readable storage media storing one or more computer programs including computer-executable instructions that, when executed by one or more processors of a user equipment, cause the user equipment to perform operations are provided. The operations include monitoring an artificial intelligence (AI) model based on at least one measurement criterion, and transmitting model related information based on a monitoring result, wherein the measurement criterion comprises one or more beam performance related measurement metrics, and wherein the measurement criterion is used to monitor/evaluate performance of the AI model.

A method performed by a terminal in a wireless communication system, the method comprising:
receiving, from a base station, a first message comprising configuration information on measurement associated with artificial intelligence (AL) or machine learning (ML) model;
identifying output of the AL or ML model; and
transmitting, to the base station, a second message comprising information on the output of the AL or ML model.

And/or wherein the output of the AL or ML model is based on performance metrics associated with at least one of beam prediction accuracy, information on link quality, or a difference of channel information.

And/or wherein the output of the AL or ML model is at least one of information on a predicted beam, information on confidence, or information on probability.

And/or further comprising:
receiving, form the base station, a third message comprising information on model management indication.

A method performed by a base station in a wireless communication system, the method comprising:
transmitting, to a terminal, a first message comprising configuration information on measurement associated with artificial intelligence (AL) or machine learning (ML) model; and
receiving, from the terminal, a second message comprising information on output of the AL or ML model.

A terminal in a wireless communication system, the terminal comprising:
a transceiver; and
at least one processor coupled with the transceiver and configured to:
receive, from a base station, a first message comprising configuration information on measurement associated with artificial intelligence (AL) or machine learning (ML) model,
identify output of the AL or ML model, and
transmit, to the base station, a second message comprising information on the output of the AL or ML model.

A base station in a wireless communication system, the base station comprising:
a transceiver; and
at least one processor coupled with the transceiver and configured to:
transmit, to a terminal, a first message comprising configuration information on measurement associated with artificial intelligence (AL) or machine learning (ML) model, and
receive, from the terminal, a second message comprising information on output of the AL or ML model.

The technical solutions provided by the embodiments of the disclosure have the following beneficial effects.

By using the solutions provided in the embodiments of the disclosure, AI/ML models can be monitored regularly, to monitor the accuracy and reliability of the AI/ML models, thereby better managing the AI/ML models and exerting the functions of the AI/ML models.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a wireless network according to an embodiment of the disclosure;

FIGS. 2A and 2B show wireless transmission and reception paths according to various embodiments of the disclosure;

FIG. 3A shows an UE 116 according to an embodiment of the disclosure;

FIG. 3B shows a gNB according to an embodiment of the disclosure;

FIG. 4 shows a flowchart of a method executed by a UE in a wireless communication system according to embodiment of the disclosure;

FIG. 5 shows a schematic diagram of a beam set for measurement and a potential transmitting beam set according to an embodiment of the disclosure;

FIG. 6 shows a relevant schematic diagram of performing model monitoring based on predicted beams and actual beams according to an embodiment of the disclosure;

FIG. 7 shows a relevant schematic diagram of predicting a future time stamp and performing model monitoring based on the results at the current or historical time stamp according to an embodiment of the disclosure;

FIG. 8 shows a schematic diagram of performing model management when the AI/ML model is implemented at the UE side according to an embodiment of the disclosure;

FIG. 9 shows a schematic diagram of performing model management when the AI/ML model is implemented at the UE side according to an embodiment of the disclosure;

FIG. 10 shows a schematic diagram of performing model management when the AI/ML model is implemented at the base station side according to an embodiment of the disclosure;

FIG. 11 shows a flowchart of a method executed by a base station in a wireless communication system according to an embodiment of the disclosure; and

FIG. 12 is a schematic structure diagram of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

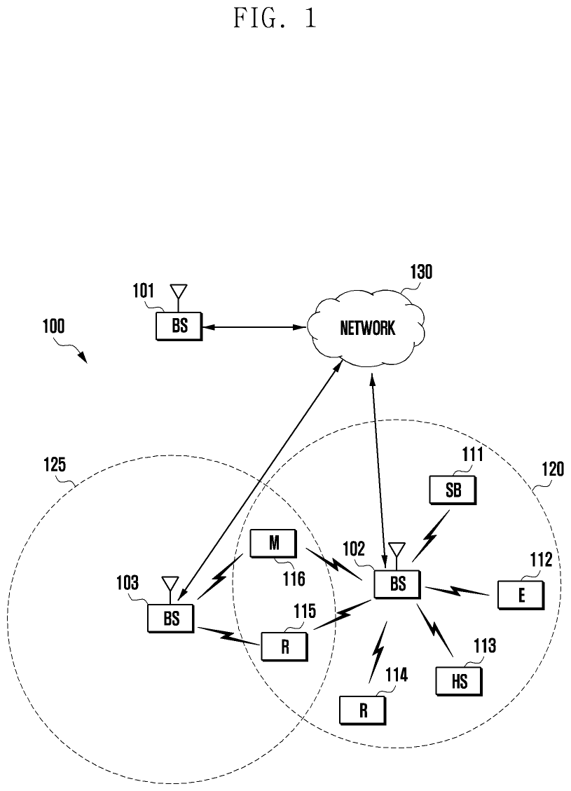

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a Wi-Fi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

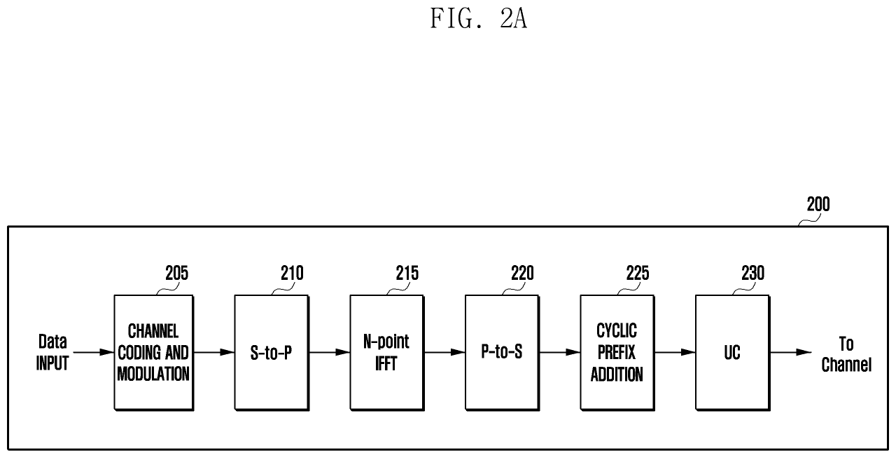

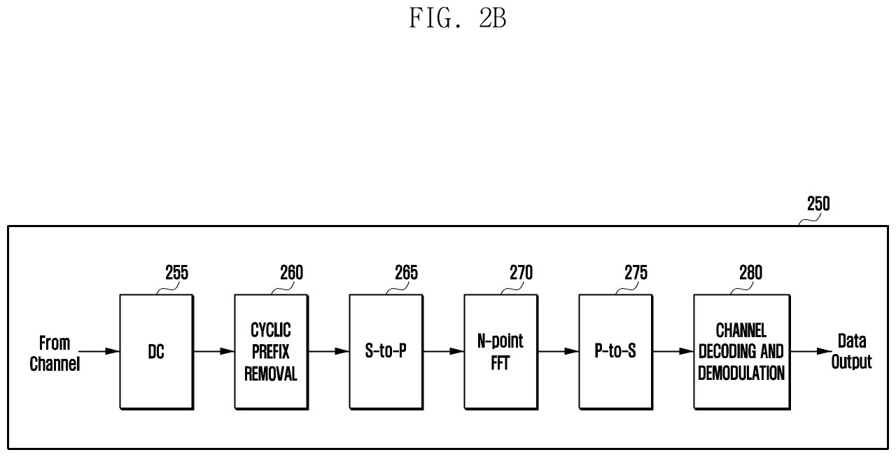

FIGS. 2A and 2B illustrate example wireless transmission and reception paths according to various embodiments of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

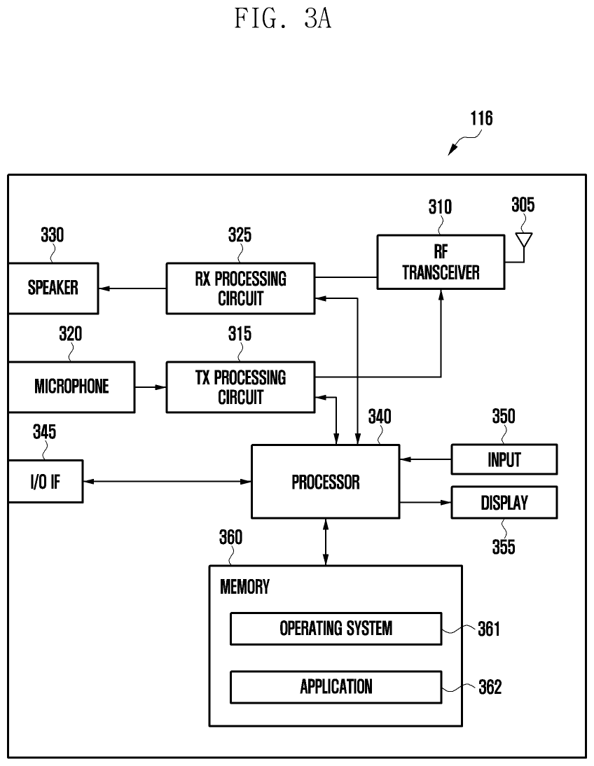

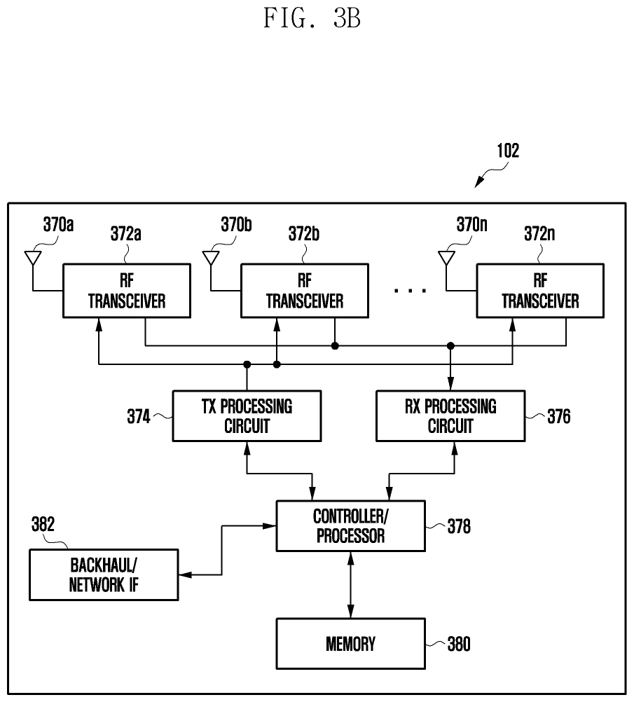

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, the UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In recent years, artificial intelligence (AI) technologies represented by deep learning algorithms have risen again to solve the problems existing in all walks of life for many years, and have achieved great success in technology and business. With the continuous evolution of wireless communication systems, these problems in air interfaces have been studied and tried to be solved by introducing new methods. In recent years, the solutions based on the AI technology have been widely studied for many problems related to the air interfaces of wireless communication, and some results theoretically better than those of the conventional algorithms have been produced. In the standardization discussion of the upcoming Rel-18 version of 3GPP in the 5G NR, the AI-based physical layer wireless communication technology is also widely discussed and will be possibly specified in the standards of 5G and/or sixth generation (6G) wireless communication technology in future.

In order to solve some problems in the communication process, machine learning methods can be used. The machine learning methods generally include the algorithm design of machine learning and the machine learning model design on which the algorithm is based. For the machine learning algorithm, there are usually two different stages, i.e., a training state and an inference stage. Generally, the machine learning model can first undergo the training stage, that is, the parameter weights in the machine learning model are learnt according to the task object. In this case, the data provided for training may be obtained online or offline. At the end of training, the machine learning model can be used for inference, that is, the tasks such as optimization, prediction, classification and regression are carried out according to the result of model training. The two stages may be carried out separately and sequentially, or may be carried out alternately.

The solutions based on the AI deep learning (DL) technology generally involve algorithms using, for example, an artificial neural network as the AI model in the machine learning technology. The deep learning network model is usually composed of multiple layers of stacked artificial neural networks. The weight parameters in the neural networks are adjusted by training the existing data, and then used for inference to achieve task objectives in the unexpected situation. Generally, compared with the general solutions or algorithms based on fixed rules, the DL-based solutions require higher operational capability than the original classical algorithms, so that a dedicated operation chip is usually needed in the device running the DL algorithm to support more efficient operation of the DL algorithm.

Using the AI algorithms based on machine learning to solve the problems in communication generally needs to satisfy the conditions of machine learning problems. Among the problems in communication and the problems related to air interfaces, many problems such as channel information feedback, reference signal estimation, beamforming and UE positioning satisfy the conditions to a certain extent and thus can be solved by machine learning algorithms, thereby achieving better effects than the conventional solutions in the communication transmission process.

Herein, the term “machine learning algorithm/model” may be interchangeably used with the “AI/ML-based technology”, “AI/ML for NR air interfaces”, “AI/ML technology”, “AI/ML architecture”, “AI/ML model”, “AI/ML for air interfaces”, “AI/ML method” and “AI/ML related algorithm”, “AI/ML-based algorithm” and “AI/ML scheme”.

The type of AI models involved in various embodiments of the disclosure may include at least one of the following: perceptron, feedforward neural network, radial basis function network, depth feedforward network, recurrent neural network, long short-term memory network, gated recurrent unit, autoencoder, variational autoencoder, denoising autoencoder, sparse autoencoder, Markov chain, Hopfield network, Boltzmann machine, restricted Boltzmann machine, deep belief network, deep convolutional network, deconvolutional neural network, deep convolutional inverse graphics network, generative adversarial network, liquid state machine, extreme learning machine, echo state network, deep residual network, Kohonen network, support vector machine, neural Turing machine, convolutional neural network, artificial neural network, deep neural network, etc. Any suitable training mode can be used to train the AI model, such as supervised training and unsupervised training.

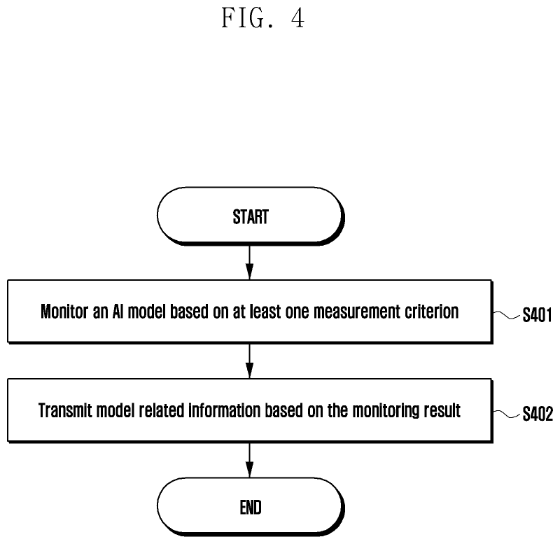

FIG. 4 is a flowchart of a method executed by a user equipment (UE) in a wireless communication system according to an embodiment of the disclosure. Referring to FIG. 4, the method may include the following operations.

In operation S401, an artificial intelligence (AI) model is monitored based on at least one measurement criterion.

The measurement criterion includes one or more beam performance related measurement metrics, and the measurement criterion is used to monitor and/or evaluate the performance of the AI model.

Specifically, the performance such as the output of the AI model is monitored. For example, the performance of the best beam (pair) or best beam (pair) set predicted according to the AI model is monitored. For example, the beam prediction accuracy, channel quality, system performance, etc. of the best beam (pair) or best beam (pair) set are monitored.

Further, the monitoring an AI model based on at least one measurement criterion includes: performing measurement (e.g., the measurement of channel state information) according to the configured reference signal (synchronization signal block (SSB), channel state information reference signal (CSI-RS), etc.), and generating a monitoring result according to the measurement result; or, performing measurement (e.g., the measurement of channel state information) according to the configured reference signal (SSB, CSI-RS, etc.), and generating AI model related information according to the measurement criterion.

In operation S402, model related information is transmitted based on the monitoring result.

The model related information includes at least one of a request for model management, a measurement result, a model management result and model management assistance information.

In an example, one or more pieces of information in the model related information are reported according to the configuration from the base station. In addition, the model related information further includes a model prediction result.

Specifically, the UE monitors the AI model based on at least one measurement criterion, and transmits model related information to a base station or an entity (e.g., a model management server) in the network based on the monitoring result, so that the management of UE-sided models by the base station, the management of UE-sided models by the UE, and the management of base station-sided models by the base station with UE assisting can be realized.

It is to be noted that the AI model or the model described in the embodiment of the disclosure may be a model constructed based on AI or ML, which is referred to as an AI/ML model hereinafter.

By using the solutions provided in the embodiments of the disclosure, AI/ML models can be regularly monitored to monitor the accuracy and reliability of the AI/ML models, thereby better managing the AI/ML models and exerting the functions of the AI/ML models.

Due to the generalization of AI/ML, one AI/ML model will have a certain range of application. If AI/ML is applied in a communication system, it is necessary to manage AI/ML models. Thus, it is necessary to define a measurement criterion for measuring the AI/ML performance.

For example, the measurement results of some beams (a part of the beam set SET_B) may be input into the AI/ML model, and one or more best beams in all beams (the set SET_A) at a certain time stamp can be selected (predicted) to assist beam management (BM). When a good (e.g., best) beam is determined from one or more beams, the measurement result of the good (e.g., best) beam may be superior to those of other beams in the one or more beams. Or, the measurement result of the good (e.g., best) beam is higher than a preset threshold. For example, there may be a plurality of good (e.g., best) beams, and the measurement results of the plurality of good (e.g., best) beams are superior than those of other beams in the one or more beams. Therefore, in some embodiments of the disclosure, “best” or “good” may not mean that there is only one beam and there may be at least one beam.

In some implementations, the set SET_B (i.e., the reference signal set SET_B1 and/or TCI set SET_B2 corresponding to the Tx beams for measurement) may be a subset of the set SET_A (i.e., the reference signal set SET_A1 and/or TCI set SET_A2 corresponding to potential Tx beams). Or, the set SET_B is a set different from the set SET_A. For example, the Tx beams corresponding to the set SET_B are wide beams for transmission (which may be briefly referred to as wide beams), while the Tx beams corresponding to the set SET_A are narrow beams (which may be briefly referred to as narrow beams). Or, the set SET_B includes the elements in the set SET_A. For example, the set SET_B includes wide beams and narrow beams, and the narrow beams are included in the set SET_A. The beams (i.e., potential Tx beams) corresponding to the set SET_A may be a full set of beams on which the base station can perform transmission, or a subset of the full set of beams on which the base station can perform transmission. For example, when there are some wide beams and some narrow beams on which the base station can perform transmission, the beams corresponding to the set SET_A may be all narrow beams in the full set of beams, or may be all wide beams and narrow beams, or may be all wide beams.

In some implementations, the information about the potential Tx beams may be preconfigured or predefined or configured by the base station. In the embodiments of the disclosure, the meaning of certain information or parameters preconfigured in the UE may be interpreted as default information or parameters embedded in the UE during the manufacturing of the UE, or information or parameters pre-acquired and stored in the UE through a higher-layer signaling (e.g., radio resource control (RRC)) configuration, or stored information or parameters acquired from the base station.

For example, the full set of beams (e.g., the set SET_A corresponding to potential Tx beams) may be based on implementation. For the base station, this set is a set of all physically realizable beams. Each beam will have a corresponding reference signal (SSB or CSI-RS). In an example, the SSB may adopt wide beams, while the CSI-RS may adopt narrow beams. In the embodiments of the disclosure, the terms “wide beam” and “narrow beam” are relative concepts, and may specifically depend on the implementation mode of the base station. For example, a wide beam may have a wide beam width than a narrow beam.

In the existing NR system, the Tx beam finally used for transmission by the base station will correspond to the transmission configuration indicator (TCI) of a known SSB or non-zero-power (NZP)-CSI-RS. No base station will adopt a TCI set corresponding to a reference signal that is not configured for the UE for measurement. In the embodiments of the disclosure, the beams (which may be identified, represented or distinguished by TCI) used by the base station to perform downlink transmission (for example, transmitting reference signals) may not be in the set SET_B for UE measurement. For example, the set of downlink beams that may be used by the base station may be the set SET_A.

In the following description, the embodiments of the disclosure may be described with respect to the Tx beam. However, the embodiments of the disclosure are not limited thereto. For example, the method described with respect to the Tx beam in the embodiments of the disclosure is also applicable to the determination of an RX beam or a Tx-Rx beam pair (a beam pair of one Tx beam and one Rx beam). For example, one or more best Rx beams are determined according to the measurement results of the set related to RX beams for measurement, wherein the best Rx beams may not belong to the measurement beam set. Or, one or more best beam pairs are determined according to the measurement results of the set related to beam pairs for measurement, wherein the best beam pairs may not belong to the set related to beam pairs for measurement. In addition, the method described with respect to the Tx beam in the embodiments of the disclosure is also applicable to the prediction of uplink transmission related beams and beam pairs by the base station or the UE. For uplink beams, the beam information is usually represented by a sounding resource indicator (SRI) or uplink TCI. For the sake of simplicity, the following description will be given by taking the set related to Tx beams.

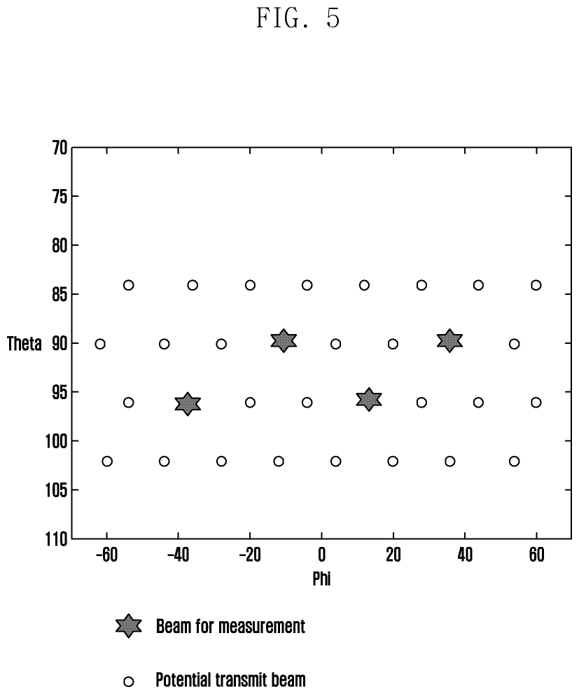

FIG. 5 shows a schematic diagram of a beam set for measurement and a potential Tx beam set according to an embodiment of the disclosure. It is to be noted that the number of beams shown in FIG. 5 is merely exemplary. In FIG. 5, the horizontal ordinate Phi and the vertical ordinate Theta are two parameters in the spatial polar coordinate system.

Referring to FIG. 5, the potential Tx beams are 4×8 32 beams. The reference signal set SET_B and/or TCI set corresponding to the potential Tx beams is the set SET_A. The reference signal set SET_B and/or TCI set for UE measurement is the set SET_B. In FIG. 5, the set SET_B includes 4 beams. In an example, the UE or base station may predict best beams in the potential Tx beam set SET_A according to the measurement results (e.g., channel impulse response (CIR), L1-RSRP) of the set SET_B by using the AI model.

When the AI/ML is used for beam management, the measurement criterion may be one or more measurement metrics and/or a decision criterion (or evaluation criterion) based on the one or more measurement metrics. Specifically, the measurement criterion may include at least one of the following.

1. The accuracy of one or more beams determined by the AI model, and/or the evaluation criterion corresponding to the accuracy of one or more beams determined by the AI model, i.e., the beam prediction accuracy and/or the decision criterion based on the beam prediction accuracy, for example, may include:
The accuracy (e.g., probability) of the predicted best beam (Top-1), and/or the relationship between the accuracy and a threshold. For example, if the probability that the predicted best beam is the actual best beam is greater than a threshold, the current model is considered to be valid; otherwise, the current model is considered to be invalid and needs to be switched, updated or deactivated.

The probability (%) that the difference of the channel stat information between the predicted best beam and of the actual best beam is within a certain range (e.g., 1 dB, 3 dB), and/or, the relationship between this probability and a threshold. For example, if the probability of that the difference of the channel information (e.g., Layer1 reference signal receiving power (L1-RSRP)) between the predicted best beam and the actual best beam is within a certain range (e.g., 1 dB, 3 dB), is greater than a threshold, the current model is considered to be valid; otherwise, the current model is considered to be invalid and needs to be switched, updated or deactivated.

The probability (%) that the predicted best beam is actual first N (e.g., N=1, 2, 3, 4, 5, . . . ) best beams. And/or the relationship between this probability and a threshold.

The accuracy that the predicted beam set includes best beams. For example, the accuracy that the predicted beams are first M (e.g., M=1, 2, 3, 4, 5, . . . ) best beams among the actual best beams). And/or the relationship between this accuracy and a threshold.

The difference (e.g., the difference in L1-RSRP) between the actual or predicted channel state information of the predicted best beam and the channel state information of the actual best beam. And/or the relationship between this difference and a threshold. In this case, if the difference in L1-RSRP is small enough, even if the predicted beam is not the actual best beam, the system performance (e.g., throughput) using the predicted beam is not far from the system performance using the actual best beam, and better performance can be obtained. If the difference is less than a threshold, the current model is considered to be valid; otherwise, the current model is considered to be invalid and needs to be switched, updated or deactivated.

When the predicted probability or accuracy is greater than a threshold, the current model is considered to be valid; otherwise, the current model is considered to be invalid and needs to be switched, updated or deactivated.

The “predicted best beam” can be considered as one or more best beams determined according to the output of the AI model. For example, the AI model directly outputs the first one or first few best beams in the predicted best beam sequence. For another example, according to the weight (e.g., the predicted L1-RSRP value, or the value representing the channel state) corresponding to each beam as the output by the AI model, one or more best beams are determined. In addition, some AI models may output one or more best beams at one or more target time stamps. For example, the sort of the best beams and/or corresponding weights of best beams at time stamp T1 and the sort of the best beams and/or corresponding weights of best beams at time stamp T2 are output at time stamps T1 and T2, respectively.

In addition, the “actual best beam(s)” (e.g., an identity (e.g., identity (ID) of the beam) or the “channel state information” of the “actual best beam(s)” may be measured in an actual system. For example, the UE may measure the channel state information of all potential Tx beams (set SET_A), and obtain one or more best beams according to the sort of the measurement results. These results may be considered as for “actual best beam(s)”. Different from the obtained “predicted best beam(s)”, the “actual best beam(s)” is one or more best beams obtained by measuring all beams in the potential Tx beam set (SET_A). The “predicted best beam(s)” is one or more best beams obtained by AI model according to the measurement results of the measurement beam set SET_B.

In order to obtain the “actual best beam(s)”, it is necessary to obtain the channel state information of all potential Tx beams in the SET_A. The base station may configure for the UE the CSI-RSs corresponding to all potential Tx beams in the set SET_A for measuring all channel state information, so as to obtain the beam prediction performance of “actual best beam(s)” and “predicted best beam(s)”, with which, the performance of the AI model is evaluated. Also, model management is performed on this.

In an example, in the configuration information for the measurement criterion, the base station may configure for the UE the CSI-RSs for the measurement of the set SET_A. The UE performs model monitoring based on the measurement results of the SET_A and the beam results output by the AI model. Specifically, the UE measures the CSI-RSs of the set SET-A to obtain the channel state information of the SET_A, and obtains “actual best beam(s)” according to the information.

In addition, for the UE-sided model, the UE may provide input to the AI model according to the channel state information of measurement set SET_B, to obtain “predicted best beams”. One or more metrics in the measurement criterion are obtained as the monitoring result. According to the measurement result, the UE performs model management, or reports the measurement result, or generates a request for model management, or reports a result, etc. Particularly, if the SET_B is a subset of the SET_A, the UE may measure the channel information of the SET_A and determine “actual best beam(s)” based on the measurement result. The results of beams in the SET_B in the channel information are selected and provided as input into the AI model to obtain “predicted best beams”. At this time, the performance of the current model can be directly reflected by comparing the results of the “actual best beam(s)” and “predicted best beam(s)”. Further, the UE may transmit a request for model management to the base station, to request the base station to configure or transmit to the UE the related information of the set SET_A for model management and/or request to transmit a reference signal related to the set SET_A. Particularly, the UE may perform model monitoring based on the measurement result of the broadcasted downlink reference signal (e.g., SSB) according to the measurement criterion. In this way, the overhead of the downlink reference signal can be saved.

In addition, the UE may transmit a part of or all of the measurement results of the set SET_A to the base station as the model related information. The base station may determine “actual best beam(s)” according to the model related information (e.g., a part of or all of the measurement results of the set SET_A) reported by the UE. The base station may compare the above results with the model prediction results to generate model management indication information, and then transmit it to the UE for model management (e.g., for the UE-sided model). Or, the base station may perform model management according to the above result.

Particularly, the beam set for obtaining “actual best beam(s)” may not be all the potential transmitting set SET_A. For example, it may be a subset SET_C of SET_A (SET_A may be replaced with SET_C in the above method). This subset SET_C may be different from the measurement set SET_B used for AI input. The SET_C may be a set that may include “actual best beam(s)” and is determined by other methods. For example, some very impossible beams may be excluded from the SET_A, or determined based on experience.

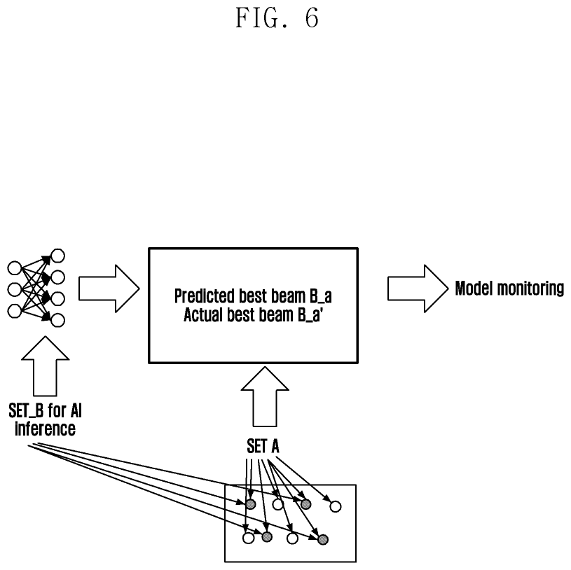

FIG. 6 shows a relevant schematic diagram of performing model monitoring based on predicted beams and actual beams according to an embodiment of the disclosure.

Referring to FIG. 6, the channel state information of the beams in the set SET_B are used for the model inference to obtain a predicted best beam B_a (e.g., beam ID, or the channel state information corresponding to this beam). In addition, an actual best beam B_a′ is obtained according to the channel state information of the beams in the set SET_A. Model monitoring is performed according to the related results of B_a and B_a′. The model inference is performed in the network (e.g., base station) or the UE or other entities. The channel state of the beams in the SET_A and/or SET_B may be measured (e.g., measured by the UE), or obtained based on the report (e.g., reported to the base station by the UE). Model monitoring may be performed at the UE or at the base station. For example, if model monitoring is performed at the UE, the UE may report the measurement result. In the example shown in FIG. 6, the measurement results of the sets SET_A and SET_B may be obtained at the same time. For example, the measurement results of the subset SET_B of the SET_A are selected and input into the AI for inference.

In addition, the beam prediction accuracy is used as the measurement criterion above, and can also be used for time-domain related beam prediction. For example, a best beam (or best beam set) at one or more future time stamps T2 is predicted according to the measurement at the current or historical time stamp T1. Thus, the beams may be measured at the prediction time stamp T2 to obtain “actual best beam(s)” or the “channel state information” of the “actual best beam(s)”. At this time, the beam accuracy may be determined by comparing the predicted best beam at the time stamp T2 with the “actual best beam(s)” measured at the moment T2. At this time, the beam sets at the time stamps T1 and T2 may be the same or different. The measurement set at the time stamp T2 may be the SET_A or SET_B. When the beam sets at the time stamps T1 and T2 are the same, the AI model is used for the time-domain prediction of the beam (the best beam in future time), and the measurement is all candidate Tx beams at the current time stamp.

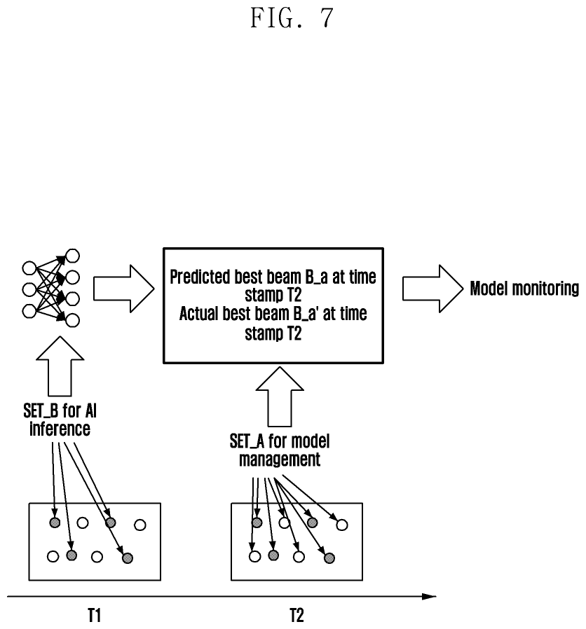

FIG. 7 shows a relevant schematic diagram of predicting a future time stamp and performing model monitoring based on the results at the current or historical time stamp according to an embodiment of the disclosure.

Referring to FIG. 7, the channel state information of the beams in the set SET_B at the time stamp T1 are used for the model inference to obtain a predicted best beam B_a (e.g., beam ID, or the channel state information corresponding to this beam) at the time stamp T2. In addition, an actual best beam B_a′ is obtained according to the channel state information of the beams in the set SET_A at the time stamp T2. Model monitoring is performed according to the related results of B_a and B_a′. The model inference is performed at the network (e.g., base station) or the UE or other entities. The channel state of the beams in the SET_A and/or SET_B may be measured (e.g., measured by the UE), or obtained based on the report (e.g., reported to the base station by the UE). Model monitoring may be performed in the UE or in the base station. For example, if model monitoring is performed at the UE, the UE may report the measurement result. In the example shown in FIG. 7, the channel state information of the beams in the set SET_A at the time stamp T2 is measured at the time stamp T2, and the measurement results of the set SET_B are measured at the time stamp T1.

In addition, in order to obtain a probability (e.g., the probability that the predicted best beam is the actual best beam), it needs to make calculation according to the results of multiple measurements. Therefore, a time window may be configured (configured for the UE by the base station) or defined to calculation the probability. The unit of this time window may be the absolute time (e.g., ms, etc.), or several time units (e.g., several symbols, slots), or several prediction time stamp s (e.g., M historical time stamps). When the UE needs to calculate the probability, the base station may configure this time window for the UE. If the base station calculates the probability, it may be realized by an algorithm.

2. The channel state information and/or channel quality of one or more beams determined by the AI model, and/or the evaluation criterion corresponding to the channel state information and/or channel quality of one or more beams determined by the AI model, i.e., the channel quality of the beam and/or the relationship between the channel quality of the beam and a threshold: the quality of the channel experienced by transmitting or receiving signals using a specific beam (or beam pair). The specific beam may be a beam decided or selected by the AI/ML model.

For example, the base station transmits a downlink signal by using a predicted transmit (Tx) beam, and the UE receives the downlink signal transmitted using this predicted beam and monitors the channel quality of this beam. Particularly, the UE may receive a downlink signal of a specific Tx beam (which may be a predicted or specified beam) by using a predicted receive (Rx) beam. It can be received whether the channel quality meets the expected performance. For example, the channel quality is higher than the preconfigured or defined specific threshold. At this time, the current model is considered to be valid; otherwise, the current model is considered to be invalid and needs to be switched, updated or deactivated, etc.

For another example, the channel quality of the current beam or beam pair is compared to other beams or beam pairs to determine whether the current beam or beam pair is the best beam (pair). Or, it is determined whether the difference between the channel quality of the current beam (pair) and the channel quality of other beams is less than (or equal to) a threshold. For example, the UE measures the channel quality of the current beam (pair) and determined whether the channel quality is lower than the channel quality of one or more other beams (pairs). Or, it is determined whether the difference between the channel quality of the current beam (pair) and the channel quality of one or more other beams (pairs) does not exceed a threshold. If the channel quality of the current beam (pair) is lower than the channel quality of one or more other beams (pairs), the current beam is not the best beam. However, if the difference between the channel quality of the current beam (pair) and the channel quality of one or more other beams (pairs) does not exceed a threshold, the current performance can be accepted although the current beam is not the best beam. At this time, the current model may be considered to be valid; otherwise, the current model is considered to be invalid and needs to be switched, updated or deactivated, etc. The current beam (pair) may be a beam that transmits (and/or receives) transmission data and/or reference signals.

Specifically, the measurement criterion for a beam is L1-RSRP, and the beam is considered to be feasible (the application of the current AI/ML model is feasible) when the L1-RSRP of the beam is higher than a threshold Q_{in,LR}. The Q _{in,LR} may configured through a higher-layer parameter, e.g., Beam-failure-candidate-beam-threshold. Since there may be an offset in the transmission power of the synchronization signal (SS)/physical broadcast channel (PBCH) block and CSI-RS, for the SS/PBCH block, the UE directly applies Q_{in,LR} to L1-RSRP; and, for the CSI-RS resource the UE scales each CSI-RS receiving power by using the value provided by the higher-layer parameter P_{c_SS}and then applies the threshold Q _{in,LR} of this CSI-RS resource to L1-RSRP.

For another example, the measurement criterion for a beam failure is the block error rate (BLER) based on the hypothetical physical downlink control channel (PDCCH). When the BLER of a certain beam is higher than a threshold Q_{out,LR} , this beam is considered to be failed (the current AI/ML model is not applicable), where Q_{out,LR} is configured through a higher-layer parameter, e.g., RLM-IS-OOS-thresholdConfig.

3. The system performance of one or more beams determined by the AI model, and/or the evaluation criterion corresponding to the system performance of one or more beams determined by the AI model, i.e., the relationship between the system performance (e.g., throughput or spectrum efficiency) and/or a threshold: the throughput or spectrum efficiency (bit/s/Hz) or rate (bit/s) that can be achieved when using the current beam to serve the user.

Specifically, if the current system performance is greater than a threshold, the current model is considered to be valid; otherwise, the current model is considered to be invalid and needs to be switched, updated or deactivated, etc.

4. The confidence of one or more beams determined by the AI model, and/or the evaluation criterion corresponding to the confidence of one or more beams determined by the AI model, the accuracy of model prediction: during training and/or inference using the AI/ML model, the confidence of the result may be output together with the result of the model. For example, when the ID of the strongest beam is predicted by a classification mode, a distribution may be output simultaneously. This distribution may be interpreted as the probability when the strongest beam is the current ID. When this probability is relatively low, it can be considered that this model is not applicable or the prediction performance of the model is not good at this time. When the probability is lower than a specific threshold or the probability is always lower than a specific threshold within a certain period of time (or the average probability within a certain period of time), it is considered that this model is not applicable and model management needs to be performed. For a UE-sided model, the UE may determine this specific threshold according to the experience, or determine this specific threshold according to the configuration from the base station. Or, the UE may report the confidence to the base station. For example, the output result and confidence of the model are reported to the base station as the model related information. It is configured, based on the configuration from the base station, whether the UE reports the confidence. The reporting format of the confidence may be predefined or configured. For example, a number of confidence thresholds may be defined or configured, and the relationship among these thresholds may be indicated by 1-4 bits. Particularly, it may be indicated by using 1-bit information whether the prediction result is higher than a threshold (e.g., 60%).

The channel state information and/or channel quality may be represented by at least one of the following:
Layer1 reference signal receiving power (L1-RSRP);
a signal to interference plus noise ratio (SINR);
a signal to noise ratio (SNR);
BLER based on the hypothetical PDCCH, where, for example, the BLER of the PDCCH is derived within a predefined or configured period of time according to the measurement of downlink reference signals in the downlink; and
a channel quality indicator (CQI), where, particularly, the index or channel quality (the highest code rate or spectrum efficiency supported by the physical downlink shared channel (PDSCH) that can achieve the specific BLER performance) of a CQI may be predefined or configured.

In an optional embodiment of the disclosure, the measurement criterion is determined by at least one of the following:
the received configuration information for the measurement criterion; and
the model information of the AI model applied in the UE.

Specifically, in an embodiment of the disclosure, the at least one measurement criterion may be determined by at least one of the following methods.

Method 1: the at least one measurement criterion is determined according to the configuration information for the measurement criterion.

The measurement criterion is configured for the UE in the configuration information for the measurement criterion. For example, one or more of the measurement criterions in the above examples are configured for the UE. The UE may perform monitoring according to the configured measurement criterion.

In addition, the configuration information for the measurement criterion may also include the information of a reference signal used for monitoring, for example, the ID of CSI-RS or SS/PBCH, beam ID, etc. In an example, the reference signal used for monitoring is different from the reference signal used for the AI model inference. Or, the configuration information also includes the time information used for monitoring, for example, the time information (e.g., slot interval, symbol interval, absolute time interval, etc.) required for channel quality measurement.

Method 2: the at least one measurement criterion is determined according to the information for monitoring the AL/ML model. The information for monitoring the AI/ML model includes at least one of the following.

The implementation entity (e.g., the UE, the base station or other entities) of the AI/ML model.

For example, if the model is implemented at the base station side, the UE measures the channel quality (e.g., L1-RSRP) of a specific reference signal at a specific time stamp. If the model is implemented at the UE side, the UE determines to switch, update, activate or deactivate according to the measurement criterion.

B) The information of applicable scenario of the AI/ML model.

For example, a number of models may be predefined or configured, where each mode has a different applicable scenario. For example, the model A is applicable to an indoor scenario, while the model B is applicable to an outdoor scenario. For another example, the model C is applicable to a low-speed (Doppler) scenario, while the model D is applicable to a high-speed (Doppler) scenario, etc. For example, according to the distribution of users, different scenarios may be defined as: dense urban area, suburban area, indoor scenario, etc. For another example, according to the cell radius, different scenarios may be defined as: for example, 200 m cell radius, 500 m cell radius, etc. For another example, different scenarios may be defined as different cells, e.g., cell-specific models; or, heights of different base stations and/or antennas; different carrier frequency points, etc.; or, in the current scenario, the distribution percentage of indoor and outdoor users in a cell. In addition, since different antenna numbers, receiving antenna panel numbers and antenna structures of the base station and/or UE have different adaptability to AI/ML, different AI/ML models may be trained (set or configured) according to different configurations of the base station and/or UE, for example, different downlink Tx beam numbers, beambooks.

In addition, for beam prediction, the relationship between different measurement beam sets (represented by set B) and prediction beam sets (represented by set A), the number of beams in the set A and the number of beams in the set B may also affect the generalization of the AI model. Therefore, the UE needs to monitor the related parameters of the set A and/or set B. Once a change occurs, a monitoring result is generated. The monitoring result may be reported to the base station, or model management may be performed according to the monitoring result. In addition, for time-domain beam prediction, different AI/ML models may be used at different prediction times. Thus, when the prediction time changes, model management also needs to be performed.

C) The identity (ID) of the AI/ML model or the functionality of the AI/ML model.

For example, one or more AI/ML models may be registered in the network (e.g., the base station or other network entities). After registration, a model ID may be obtained. Thus, different models (e.g., models applicable to different application scenarios) may apply different measurement criterions. Therefore, different measurement criterions may be configured or defined for each model. Thus, the UE may determine the measurement criterion of this model according to the model ID.

D) The input and/or output of the AI/ML model.

For example, if the output of an AI/ML model is the ID of the predicted best beam, the prediction accuracy may be configured or defined as the measurement criterion. For another example, if the output parameter of an AI/ML model is the L1-RSRP value of the predicted best beam, the difference between the predicted value and the measurement of L1-RSRP may be configured or defined as the measurement criterion.

In an embodiment of the disclosure, the UE may determine, according to the trigger condition, whether to transmit the model related information. The trigger condition may be at least one of the following: AI model management is performed; a request for AI model management is generated; and, the measurement result exceeds a threshold. The trigger condition is obtained according to the base station configuration or by predefining. For example, if the UE has performed the AI model management, the result of AI model management needs to be reported to the base station. For another example, if the UE determines to make a request for AI model management according to the at least one measurement criterion, the request for model management is reported. Or, when one or more measurement results exceed the threshold, the model related information is transmitted. For example, when the channel quality is lower than a specific value or a link failure or beam switch request is triggered, this request is transmitted. In another example, if the information related to the scenario corresponding to the current model or the generalization of other AI models changes, the model needs to be switched, and the model related information is transmitted.

In addition, the AI/ML can improve the prediction accuracy or manage models by virtue of some assistance information. Generally, the assistance information is related to the generalization of the AI model. For example, the assistance information is some scenario information, the environmental information of the UE, the capability information, etc. A suitable model may be selected (switched, updated, activated, etc.) according to the different assistance information and according to the applicable scenario of the model. Therefore, the UE may also report the assistance information to the base station to assist in the determination of the AI model management. Particularly for the base station-sided AI/ML model, the assistance information may assist the base station in model management. The assistance information includes at least one of the following:
the environmental information of the UE: for example, the position information of the UE, the environmental information of the UE, the movement speed information of the UE, the motion direction information of the UE, the rotation direction information of the UE, or the receiving angle information, Doppler information, time-domain related information, etc. of the UE;
the capability information of the UE: the receiving antenna information (e.g., number) of the UE, the antenna panel number, the antenna panel type, the information of one or more Rx beams of the UE, etc.;
the information of the UE-sided AI model;
the information of the model itself: for example, the backbone of the model, the ID of the AI model, the application scenario of the AI mode, etc.;
generalization related information: for example, predicted beam information (e.g., the number of beams in the SetA), measured beam information (e.g., the number of beams in the SetB), etc.; and
the time required by the UE to apply the AI model, where the time required by the UE for different AI models may be different.

Various model management scenarios in the embodiments of the disclosure will be described below. ps Management of UE-sided Model by the Base Station

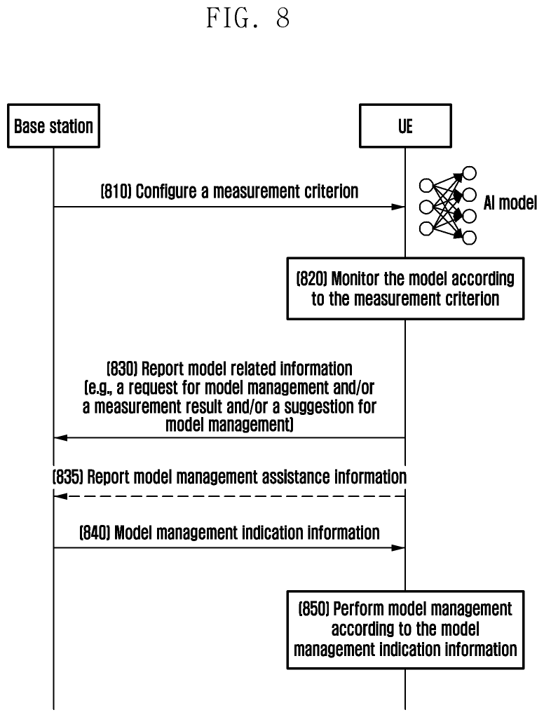

FIG. 8 shows a schematic diagram of performing model management when the AI/ML model is implemented at the UE side according to an embodiment of the disclosure.

Referring to FIG. 8, the UE receives at least one measurement criterion configured by the base station in operation 810. The UE monitors a model according to the measurement criterion in operation 820, and reports model related information to the base station based on the generated monitoring result in operation 830. Specifically, at least one of the following methods may be included.

1. The UE reports a measurement result to the base station.

The UE applies an AI/ML model, for example, to predict, according to the beam measurement result, a best beam (pair) or best beam (pair) set in the beam set at a future time stamp or in the beam set with un-measured beams. The UE monitors the performance of the result of applying this AI/ML model. For example, when the future time stamp arrives, the channel quality of the predicted beam is measured. The measurement result is reported to the base station according to the at least one measurement criterion configured by the base station, for example, beam prediction accuracy, beam quality, system performance, etc.; for example, the L1-RSRP value of the predicted value, etc.

After the information is reported, the UE receives the model management indication information in operation 840, and performs model management according to the model management indication information.

Operation 820. The UE reports a request for model management or a suggestion for model management to the base station.

The UE applies an AI/ML model, for example, to predict, according to the beam measurement result, a best beam (pair) or best beam (pair) set in the beam set that is at a future time stamp or in the beam set with un-measured beams. The UE monitors the performance of the result of applying this AI/ML model. For example, when the future time stamp arrives, the channel quality of this predicted beam is measured, and it is determined whether to perform model management and/or generate a request for model management according to one or more measurement metrics configured in the measurement criterion and/or the decision criterion corresponding to the one or more measurement metrics. For example, if the channel quality of the beam is lower than a threshold, the current AI/ML model is failed and should be managed, and a request for model management is generated and reported to the base station.

After the information is reported, the UE receives the model management indication information, and performs model management according to the model management indication information in operation 850.

In addition, in operation 835, the UE may also report, to the base station, assistance information for assisting the determination of AI/ML model management, so as to assist the base station to perform model management.

Further, with reference to FIG. 8 again, the model management process in this scenario may include the following steps.
(1) Obtaining, a measurement criterion, by the UE, configured from the base station.
(2) Monitoring, by the UE, a model according to the measurement criterion.
(3) Reporting, by the UE, model related information (e.g., a request for model management and/or a measurement result and/or a suggestion for model management) to the base station. In addition, a step (3′) of reporting model management assistance information to the base station by the UE may also be included.
(4) Receiving, by the UE, model management indication information issued by the base station to the UE.
(5) Performing, by the UE, Model management according to the model management indication information.

### Management of the UE-sided Model by the UE

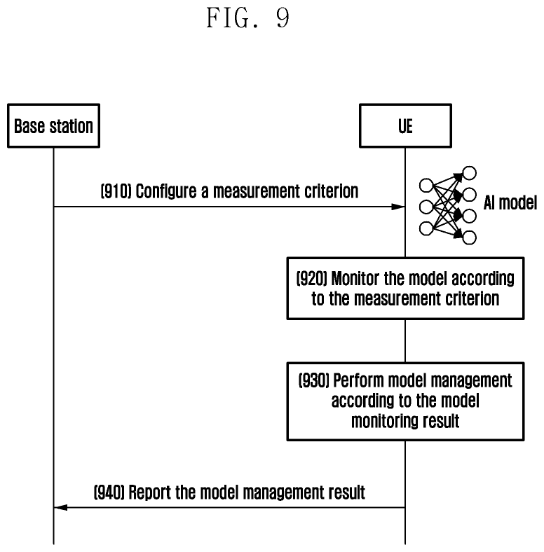

FIG. 9 shows a schematic diagram of performing model management when the AI/ML model is implemented at the UE side according to an embodiment of the disclosure.

Referring to FIG. 9, the UE receives at least one measurement criterion configured by the base station in operation 910. The UE applies an AI/ML model, monitors the model according to the measurement criterion in operation 920, and performs model management according to the model monitoring result in operation 930.

For example, the UE applies an AI/ML model, for example, to predict, according to the beam measurement result, a best beam (pair) or best beam (pair) set in the beam set at a future time stamp or in the beam set with un-measured beams. The UE monitors the performance of the result of applying this AI/ML model. For example, when the future time stamp arrives, the channel quality of this predicted beam is measured, and it is determined whether to perform model management according to one or more measurement metrics configured in the measurement criterion and/or the decision criterion corresponding to the one or more measurement metrics. For example, if the channel quality of the beam is lower than a threshold, the current AI/ML model is failed and should be managed.

In operation 940, the UE reports the model management result. For example, the UE reports whether to perform model switching, activation, model updating, model activation (without using the AI/ML model). The advantage of reporting the model management or measurement result to the base station is that the base station can know the operation of the UE in model management and the base station can thus adjust the configuration. For example, if the UE cannot perform beam prediction, the base station needs to perform beam management according to the conventional method. In an example, a signaling may be designed to indicate whether the UE performs model management and/or which model management is performed. For example, the UE reports that base station that the UE switches from the AI/ML model 1 to the model 2. For another example, the UE reports to the base station that the UE deactivates the AI/ML model. In addition, no AI/ML model is adopted in the current state and the UE determines according to the measurement criterion that a certain AI/ML model is suitable, the UE may activate the AI/ML model. Upon receiving the report information, the base station may adjust the configuration according to the model management result of the UE, thereby achieving better system performance.

Further, with reference to FIG. 9 again, the model management process in this scenario may include the following steps.
(1) Obtaining a configuration of measurement criterion, by the UE, from the base station for the UE.
(2) Monitoring, by the UE, a model according to the measurement criterion.
(3) Performing, by the UE, model management according to the model monitoring result.
(4) Reporting, by the UE, a model management result to the base station. Management of base station-sided model by the base station with UE assisting

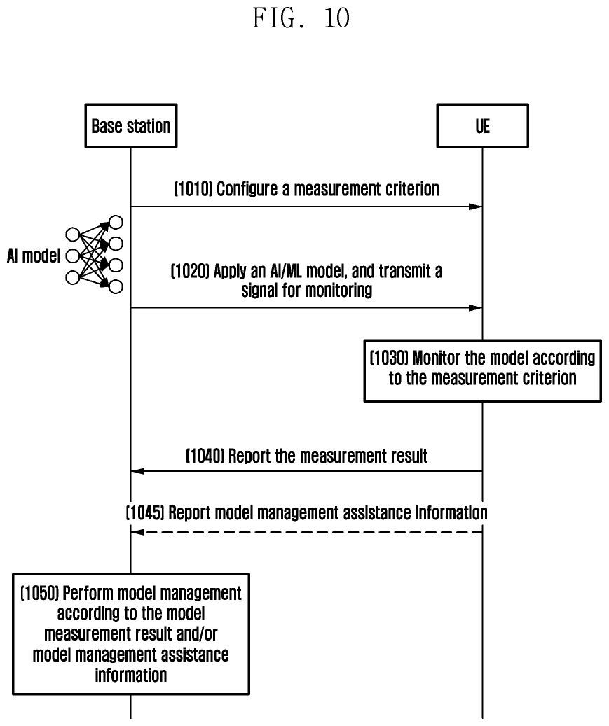

FIG. 10 shows a schematic diagram of performing model management when the AI/ML model is implemented at the base station side according to an embodiment of the disclosure.

Referring to FIG. 10, the UE receives at least one measurement criterion configured by the base station in operation 1010. The base station applies an AI/ML model, and transmits a downlink signal according to the model in operation 1020. For example, the downlink signal is transmitted according to the predicted best beam. The UE monitors the downlink signal transmitted by applying the model according to the measurement criterion in operation 1030, and generates a monitoring result. The UE reports the measurement result to the base station based on the monitoring result in operation 1040. For example, the UE measures the channel quality of the downlink beam at a certain time stamp, and reports the measurement result to the base station, for example, beam prediction accuracy, beam quality, system performance, etc.; for example, the L1-RSRP value of the predicted value, etc.

Upon receiving the measurement result reported by the UE, the base station may perform model management based on the received measurement result in operation 1050.

In addition, in operation 1045 the UE may also report, to the base station, assistance information for assisting the determination of AI/ML model management, so as to assist the base station to perform model management. The base station performs model management according to the monitoring result and/or assistance information. p Further, with reference to FIG. 10 again, the model management process in this scenario may include the following steps.
(1) Obtaining the configuring from the base station a measurement criterion for the UE.
(2) Receiving, by the UE, a signal for monitoring from the base station, wherein an AI/ML model is applied at the base station.
(3) Monitoring, by the UE, the model according to the measurement criterion.
(4) Reporting, by the UE, the measurement result to the base station. In addition, a step (4′) of reporting model management assistance information to the base station by the UE may also be included.
(5) Performing model management, by the base station, according to the model measurement result and/or model management assistance information.

The model management will be described below.

The base station or UE may manage the AI/ML model according to the performance of applying the AI/ML model and/or the current scenario or other assistance information. The model management may include at least one of the following:
model updating or model retraining: updating AI/ML model parameters and/or AI/ML model structures; the model updating includes model parameter updating and/or model structure updating;
model selection: selecting one or more AI/ML models from a plurality of AI/ML models for use;
model transformation (switching): stopping (deactivating) the current AI/ML model, and using (activating) another AI/ML model;
model activation: using an AI/ML model;
model deactivation: stopping the use of an AI/ML model; further, the functionality of the AI/ML model may be replaced by choosing non-AL-ML (fallback);
model downloading: downloading and/or applying an AI/ML model from the base station or server; and
model uploading: uploading an AI/ML model to the server or base station.

In addition, the UE may be instructed to perform model management through the model management indication information. Or, the UE may transmit the model management result to the base station. The model management indication information may include at least one of the following:
information indicating model updating or model retraining: the information may indicate whether to update model parameters and/or model structures;
information indicating model selection or transformation (switching): for example, the information may be a model ID or the scenario of a model; the information indicating model selection may indicate activating this model; if there is a model that is applying currently (a model with the same purpose), the current model is stopped (deactivated);
information indicating model activation: the information may be the ID of a model or the scenario of a model; or, the information may be 1 bit for indicating whether to activate a specific model;
information indicating model deactivation: the information may be the ID of a model or the scenario of a model; or, the information may be 1 bit for indicating whether to deactivate a specific model; further, if an AI/ML model is deactivated, it indicates that the functionality of the AI/ML model is replaced by choosing non-AI (fallback);
information indicating model downloading: indicating whether to download and/or apply an AI/ML model and/or related information of the model (e.g., applicable scenario, configuration parameters, etc.) from the base station or server; and
information indicating model uploading: indicating whether to upload an AI/ML model and the related information of the model (e.g., applicable scenario, configuration parameters, etc.) to the server or the base station.

In addition, the model management result of the UE may be informed to the base station or model management server through the model processing result. The model management result may include at least one of the following:
information indicating whether model updating or model retraining is performed;
information indicating whether model selection or transformation (switching) is performed;
information indicating whether model activation is performed;
information indicating whether model deactivation is performed;
information indicating whether model downloading is performed; and
information indicating whether model uploading is performed.

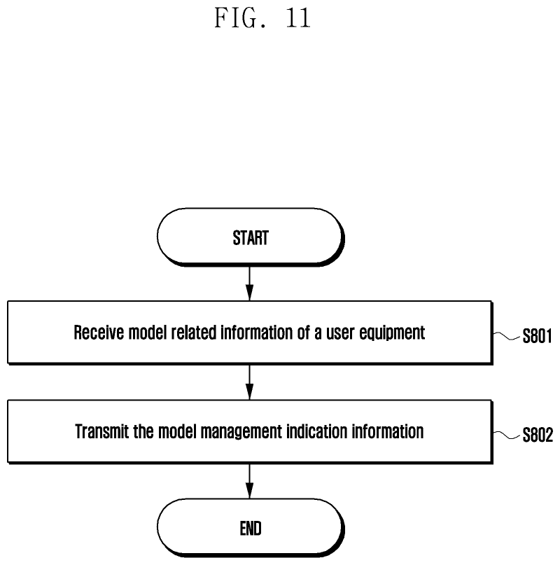

FIG. 11 is a flowchart of a method executed by a base station in a wireless communication system according to an embodiment of the disclosure. Referring to FIG. 11, the method may include the following operations.

In operation S801, model related information of a user equipment (UE) is received, the model related information being determined by monitoring an artificial intelligence (AI) model based on at least one measurement criterion by the UE. In operation S802, model management indication information is transmitted.

The measurement criterion includes one or more beam performance related measurement metrics, and the measurement criterion is used to monitor/evaluate the performance of the AI model.

Similarly, the method provided in the embodiment of the disclosure corresponds to the method in the embodiments at the UE side, and the detailed functional descriptions and the achieved beneficial effects can specifically refer to the above descriptions of the corresponding method in the embodiments at the UE side and will not be repeated here.

The solutions of the disclosure are applied to (but not limited to) systems using artificial intelligence or machine learning algorithms. The artificial intelligence or machine learning algorithms may be deployed at the base station side, or the artificial intelligence or machine learning algorithms may be deployed on the terminal side.

At least some of the functions in the electronic device (e.g., the terminal or the base station) provided in the embodiments of the disclosure may be implemented by an AI model. For example, at least one of a plurality of modules (functional units) of the electronic device may be implemented by an AI model. The AI-associated functions may be performed through a non-volatile memory, a volatile memory, and a processor. The processor may include one or more processors. In this case, the one or more processors may be general-purpose processors such as central processing units (CPUs), application processors (APs), etc., or pure graphics processing units such as graphics processing units (GPUs), visual processing Units (VPUs), and/or AI-specific processors such as neural processing units (NPUs).

The one or more processors control processing of input data based on predefined operating rules or artificial intelligence (AI) models stored in non-volatile and volatile memory. The predefined operating rules or AI models are provided through training or learning (e.g., machine learning).

Here, providing by learning refers to obtaining predefined operating rules or AI models with desired characteristics by applying a learning algorithm to a plurality of learning data. The learning may be performed in the device or electronic device itself in which the AI according to embodiments is performed, and/or may be realized by a separate server/system.

Embodiments of the disclosure also provide an electronic device comprising a processor, optionally further comprising a transceiver and/or memory coupled to the processor, the processor being configured to perform the steps of the method provided in any optional embodiment of the disclosure.

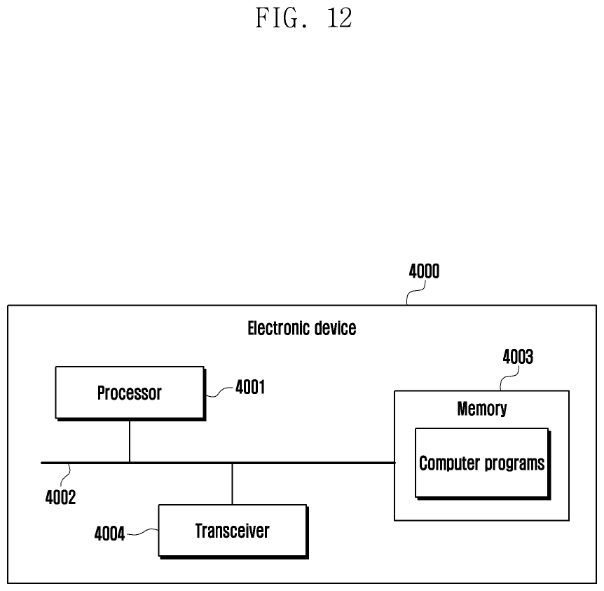

FIG. 12 is a schematic structure diagram of an electronic device according to an embodiment of the disclosure.

In an optional embodiment, there is provided an electronic equipment, as shown in FIG. 12, an electronic equipment 4000 illustrated in FIG. 12 comprises a processor 4001 and memory 4003. Wherein, the processor 1901 is connected to memory 4003, such as connected through a bus 4002. Optionally, the electronic equipment 4000 can further comprise a transceiver 4004, the transceiver 1904 can be used for data interaction between the electronic equipment and other electronic equipments, such as transmission of data and/or reception of data, and so on. As should be noted, in an actual application the transceiver 4004 is not limited to one, and the structure of the electronic equipment 4000 does not constitute any restriction to the embodiments of the disclosure.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various logical blocks, modules and circuits described in connection with the disclosure. The processor 4001 may also be a combination for realizing computing functions, for example, a combination of one or more microprocessors, a combination of a DSP and a microprocessor, etc.

The bus 4002 may include a path to transfer information between the components described above. The bus 1902 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 12. However, it does not mean that there is only one bus or one type of buses.

The memory 4003 may be read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store application program codes for executing the embodiment of the disclosure, and is controlled by the processor 1901. The processor 1901 is used to execute the application program codes stored in the memory 1903 to implement the step shown in the foregoing method embodiment.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of the disclosure and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a first message comprising configuration information on measurement associated with artificial intelligence (AL) or machine learning (ML) model;
identifying output of the AL or ML model; and
transmitting, to the base station, a second message comprising information on the output of the AL or ML model.

2. The method of claim 1, wherein the output of the AL or ML model is based on performance metrics associated with at least one of beam prediction accuracy, information on link quality, or a difference of channel information.

3. The method of claim 1, wherein the output of the AL or ML model is at least one of information on a predicted beam, information on confidence, or information on probability.

4. The method of claim 1, further comprising:
receiving, form the base station, a third message comprising information on model management indication.

5. A method performed by a base station in a wireless communication system, the method comprising:
transmitting, to a terminal, a first message comprising configuration information on measurement associated with artificial intelligence (AL) or machine learning (ML) model; and
receiving, from the terminal, a second message comprising information on output of the AL or ML model.

6. The method of claim 5, wherein the output of the AL or ML model is based on performance metrics associated with at least one of beam prediction accuracy, information on link quality, or a difference of channel information.

7. The method of claim 5, wherein the output of the AL or ML model is at least one of information on a predicted beam, information on confidence, or information on probability.

8. The method of claim 5, further comprising:
transmitting, to the terminal, a third message comprising information on model management indication.

9. A terminal in a wireless communication system, the terminal comprising:
a transceiver; and
at least one processor coupled with the transceiver and configured to:
receive, from a base station, a first message comprising configuration information on measurement associated with artificial intelligence (AL) or machine learning (ML) model,
identify output of the AL or ML model, and
transmit, to the base station, a second message comprising information on the output of the AL or ML model.

10. The terminal of claim 9, wherein the output of the AL or ML model is based on performance metrics associated with at least one of beam prediction accuracy, information on link quality, or a difference of channel information.

11. The terminal of claim 9, wherein the output of the AL or ML model is at least one of information on a predicted beam, information on confidence, or information on probability.

12. The terminal of claim 9, wherein the at least one processor is configured to:
receive, form the base station, a third message comprising information on model management indication.

13. A base station in a wireless communication system, the base station comprising:
a transceiver; and
at least one processor coupled with the transceiver and configured to:
transmit, to a terminal, a first message comprising configuration information on measurement associated with artificial intelligence (AL) or machine learning (ML) model, and
receive, from the terminal, a second message comprising information on output of the AL or ML model.

14. The base station of claim 13, wherein the output of the AL or ML model is based on performance metrics associated with at least one of beam prediction accuracy, information on link quality, or a difference of channel information.

15. The base station of claim 13, wherein the output of the AL or ML model is at least one of information on a predicted beam, information on confidence, or information on probability.

16. The base station of claim 13, wherein the at least one processor is configured to:
transmit, to the terminal, a third message comprising information on model management indication.
